(19) United States
(12) Patent Application Publication
(10) Pub. No.: US 2024/0353380 A1
(43) Pub. Date: Oct. 24, 2024

(54) AUTOMATED CHROMATOGRAPHY SYSTEMS AND METHODS

(71) Applicant: Life Technologies Corporation, Carlsbad, CA (US)

(72) Inventors: Declan Crowley, Leeds (GB); Kristina Pleitt, Cottleville, MO (US); Philip Jacobsen, Newton, MA (US); Claudia Michelle Nolasco Rivera, St. Louis, MO (US); Krystle A. PRANTIL, Quincy, MA (US); John P. Greenwood, San Jose, CA (US)

(21) Appl. No.: 18/642,638

(22) Filed: Apr. 22, 2024

Related U.S. Application Data
(60) Provisional application No. 63/497,806, filed on Apr. 24, 2023.
(60) Provisional application No. 63/592,015, filed on Oct. 20, 2023.
(60) Provisional application No. 63/528,848, filed on Jul. 25, 2023.

(51) Int. Cl. G01N 30/34; G01N 30/32; G01N 30/86

(52) U.S. Cl. CPC G01N 30/34; G01N 30/32; G01N 30/8651

(57) ABSTRACT

The present disclosure relates to systems and methods for efficiently and easily implementing user-friendly purification operations and recipes to purify a target molecule by column chromatography. More specifically, the present application and disclosure relate to chromatography instrument control system modules, libraries and user interfaces used to control a chromatography instrument. The systems and methods are configured to provide a user with the ability to create, modify, recall, store, organize, prioritize, and run complex purification recipes to control a piece of chromatography equipment through a system controller and one or more graphical user interfaces.

### CROSS-REFERENCE TO RELATED APPLICATIONS

This application claims the benefit of priority to U.S. Provisional Patent Application Ser. No. 63/592,015, filed on Oct. 20, 2023 and titled “AUTOMATED CHROMATOGRAPHY SYSTEMS AND METHODS,” U.S. Provisional Patent Application Ser. No. 63/497,806, filed on Apr. 24, 2023 and titled “AUTOMATED CHROMATOGRAPHY SYSTEMS AND METHODS, and U.S. Provisional Patent Application Ser. No. 63/528,848, filed on Jul. 25, 2023 and titled “AUTOMATED CHROMATOGRAPHY SYSTEMS AND METHODS, the contents of each of which are incorporated herein by specific reference in their entireties.

### FIELD OF THE DISCLOSURE

The present application and disclosure relate to automated chromatography systems and methods. More specifically, the present application and disclosure relate to control system modules, libraries, and graphical user interfaces used to control the operations of a chromatography instrument.

### BACKGROUND

Chromatography systems are used in the separation of mixtures. Mixtures can include biological components, such as recombinant proteins, monoclonal antibodies, and viral vectors. The automation of chromatography systems is complicated by the need for a user to be sufficiently trained to operate on complex user interfaces to create, modify, organize, and run complex purification recipes including a plurality of recipe parameters. The recipes can be for batch or non-batch operations, including discrete steps requiring user input for various parameters, such as input manifold selection, column selection, output manifold selection, elution protocol, eluant or buffer solution selection, column equilibration, sample loading, column washing, product elution, and other parameters.

Naturally, updating parameters in a recipe can be laborious and cumbersome even for experienced users, let alone new users, as existing chromatography systems mandate a thorough knowledge of the backend software structure. This issue is exacerbated by the user interfaces used in connection with such chromatography systems, as the same is typically not easily adaptable for use in connection with different chromatography equipment, thereby requiring additional process steps for both set-up and recipe-building tasks. In many cases, these complications hamper the efficient automation and process control in chromatography systems.

Time-efficient, cost-effective, user-friendly, and easily optimizable automated chromatography systems and methods disclosed herein solve all or some of the above-identified shortcomings and other deficiencies known in the art.

### BRIEF DESCRIPTION OF THE DRAWINGS

Various embodiments of the present disclosure are discussed with reference to the appended drawings described below. The drawings depict features and embodiments of the systems and methods disclosed and claimed herein. Additions, substitutions, and modifications can be made to features and embodiments specifically depicted in the drawings without departing from the invention or scope thereof. Therefore, the drawings are not to be considered limiting in scope.

FIG. 1A is a block diagram of an automated chromatography system in accordance with example embodiments.

FIG. 1B is a front perspective view of a chromatography unit in accordance with example embodiments.

FIG. 1C depicts a block diagram of a user workstation, in accordance with at least one embodiment of the present invention.

FIG. 2 is a screenshot of a main screen displayed on a client computing device in accordance with example embodiments.

FIG. 3A to FIG. 3F illustrate schematic diagrams of various modules of a chromatography system in accordance with example embodiments.

FIG. 4A to FIG. 4T illustrate various user interfaces displayed on a client computing device in accordance with example embodiments.

FIG. 5 is a flow diagram of a method for operating a chromatography system in accordance with example embodiments.

### DETAILED DESCRIPTION OF THE PREFERRED EMBODIMENTS

Before describing the present disclosure in detail, it is to be understood that this disclosure is not limited to particularly exemplified apparatus, systems, methods, or process parameters that may, of course, vary. It is also to be understood that the terminology used herein is only for the purpose of describing particular embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, a reference to a “partition” includes one, two, or more partitions.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” or two alternative embodiments of a particular element may be labeled as “10a” and “10b”. In that case, the element label may be used without an appended letter (e.g., “10”) to generally refer to all instances of the element or any one of the elements. Element labels, including an appended letter (e.g., “10a”) can be used to refer to a specific instance of the element or to distinguish or draw attention to multiple uses of the element. Furthermore, an element label with an appended letter can be used to designate an alternative design, structure, function, implementation, and/or embodiment of an element or feature without an appended letter. Likewise, an element label with an appended letter can be used to indicate a sub-element of a parent element. For instance, an element “12” can comprise sub-elements or surfaces “12a” and “12b.”

Various aspects of the present devices and systems may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, systems, and methods may be illustrated with reference to one or more example embodiments. As used herein, the term “embodiment” means “serving as an example, instance, or illustration,” and should not necessarily be construed as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

Automated chromatography systems disclosed herein are used for the separation of biological components or biocomponents. Biocomponents can include biological fluids, solids, mixtures, solutions, and suspensions comprising, for example, media, cells, blood, plasma, organelles, proteins, nucleic acids, monoclonal antibodies, lipids, plasmids, viral vectors, and/or carbohydrates dissolved or dispersed in biological mixtures, solutions, and suspensions. For example, a mixture including a target molecule of interest can be loaded into chromatography matrices including columns, membranes, and monoliths for separation and purification. A matrix housed within the column is specifically engineered to capture or slow the flow of the target molecule while the remainder of the mixture can more freely flow through and out of the column. Upon eluting the column with a suitable eluant or buffer solution, the target molecule is isolated free of other components. The selection of an appropriate buffer solution is critical and is dependent on the properties of the matrix and the target molecule. An isocratic elution uses a single buffer solution having the same polarity, whereas a gradient elution uses more than one buffer solution and can include a gradual increase or decrease of the polarity of the buffer solution throughout the process of separation.

Chromatography systems herein disclosed use a variety of fluids, equipment, sensors, valves, pumps, flow paths, fluid transfer assemblies, purification recipes, recipe parameters, and purification processes. Accordingly, a recipe to be used in connection with a chromatography system can utilize any and/or all of these components, and, as may be understood, the recipe steps therefor may define certain batch operations to be performed, such as column equilibration, sample loading, column washing, one or more sensor calibration using appropriate buffer solutions, and product elution.

One common issue arises when a user must update a recipe parameter for a recipe step in a chromatography unit. Specifically, to update or change one or more recipe parameters for a recipe, an entire recipe needs to be revisited before specific parameters may be selected and subsequently updated. Such an update for recipe parameters in complex recipes calls for users to have sufficient experience and training in backend software applications, hence making it a difficult process for experienced users and even more for new users. The example automated chromatography systems disclosed herein address the above complications and problems.

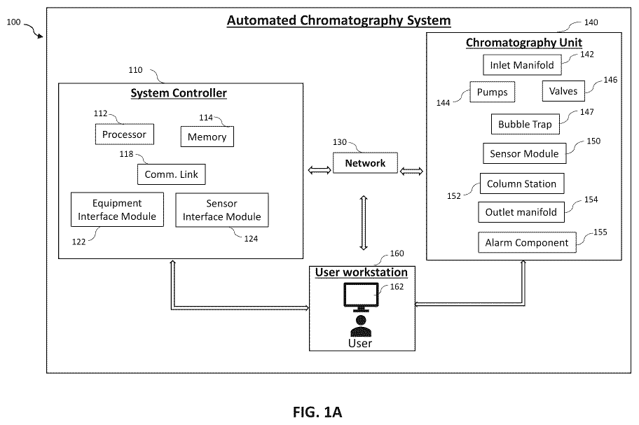

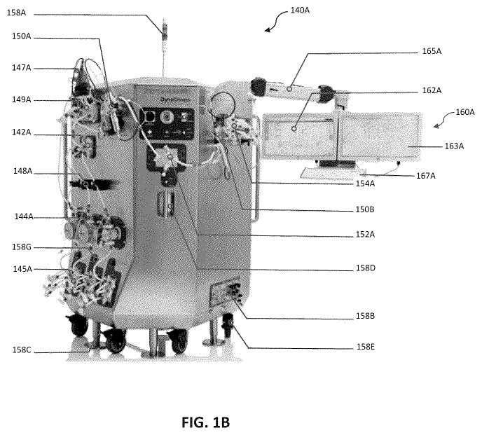

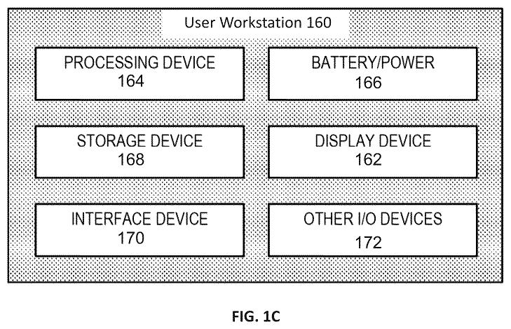

FIG. 1A is a block diagram of an automated chromatography system 100 in accordance with example embodiments. In general, chromatography system 100 is designed to separate a mixture to isolate and collect a molecule(s) of interest from a mixture by a time-efficient and cost-effective automated chromatography protocol. The automated chromatography system 100 of at least one embodiment of the present invention can include a system controller 110 in electronic communication with a chromatography unit 140, and a user workstation 160 that can be operated by a user. A network 130 (Ethernet IP switch or other communications switch, hub, or router) functions as a router to facilitate and balance communications and data transmission between the system controller 110, chromatography unit 140, and user workstation 160. Other communication links, routers, or switches can also be used to facilitate and balance communications and data transmission between the system controller 110, chromatography unit 140, and user workstation 160.

System controller 110 includes at least one processor 112 and at least one associated memory 114 for storing instructions, which, when executed by at least one processor 112, is configured to perform one or more operations. Further, a communication link 118 facilitates electronic communication between controller 110, chromatography unit 140, and user workstation 160, via network 130. Communication link 118 can include any wired and/or wireless network including, for example, a wide area network (WAN), a local area network (LAN), a virtual local area network (VLAN), a public land mobile network (PLMN), the Internet, and/or the like. All data interactions including sending, receiving, writing, overwriting, copying instructions between above components, namely controller 110, chromatography unit 140, sensors 150 and associated transmitters, other components therein, and user workstation 160 can be stored in memory 114.

In some implementations, memory 114 can be a centralized repository designed to store, process, and secure large amounts of structured, semi-structured, and unstructured data. For example, memory 114, can include data sets related to one or more user instructions including recipe step details, ordered list of recipe steps, old recipe parameters, new recipe parameters, sensors details and status, parameters measured by one or more sensors, fluid parameters, a plurality of process liquids, physical parameters specific to each process liquid, parameters specific to a sensor, and parameters specific to the chromatography unit 140, components thereof, and any other combination of parameters thereof. In other words, memory 114 can be configured to store and/or process, receive, and send the data received from/to chromatography unit 140 and serve as a source of data, inputs, and outputs for user workstation 160. For example, a warehouse receiving a process liquid (e.g., buffer solution) can scan a barcode associated with the process liquid and save parameters associated with the process liquid in memory 114, including liquid and sensor parameter sets, composition, density, specific density, viscosity, mass, heat capacity, volume, temperature and/or other fluid properties of the process liquid. The liquid, sensor, and physical parameters can then be recalled from memory 114 and used during one or more chromatography processes or operations, such as a startup operation or purification operation dictated respectively by a startup recipe or purification recipe. In various embodiments, portions of data stored in memory 114 can be transferred to plant or large-scale applications, while other portions of data can be used for bench-scale applications in a laboratory environment. In some examples, data stored in memory 114 can be used for data analytics and predictive protocols.

Further, system controller 110, includes an equipment interface module 122 and a sensor interface module 124, configured to generally interface with, receive and transmit readings and data to and from one or more operational components, peripherals, or equipment (pumps, valves, inlet/outlet manifolds) associated transmitters and sensors and associated transmitters of the chromatography unit 140. In various embodiments, the system controller 110 can be a single unit or a distributed control system with a client-side control component for client inputs and outputs and a plant-side control component closer in proximity to the bioproduction process or plant.

Chromatography unit 140 can include inlet manifold 142, a plurality of valve units 146 (e.g., automated valve manifolds), a plurality of pumps 144, a bubble trap 147, a plurality of sensors 150, a column station 152, and an outlet manifold 154 (e.g., automated valve manifold), alarm component 155, and/or other peripherals, instruments, and equipment used in a chromatography unit 140. A user can control operations of chromatography unit 140 via a user interface or display device 162 displayed on user workstation 160. User interface 162 can include user inputs and readable instrument and process parameter outputs for controlling and monitoring chromatography unit 140 through system controller 110.

In example embodiments, chromatography system 100 is the Thermo Scientific™ DynaChrom™ Single-Use Chromatography System or similar system. Additional chromatography system 100 and associated features and components are disclosed in WO 2022/126115, which is hereby incorporated by reference in its entirety herein. Chromatography system 100 can serve as a compact downstream purification system, which is designed to meet the needs of process scale-up and cGMP manufacturing. The DynaChrom™ Single-Use Chromatography System and other example chromatography units 140 can utilize modular, single-use fluid transfer assemblies, industry-standard sensor technology, innovative valve technology, and robust automation. Alternatively, chromatography unit 140 can be any other chromatography unit having chromatography matrices equipped for separation of a target molecule, including anion exchange chromatography, protein A chromatography, size exclusion chromatography or any other chromatography technique which falls under scope of this disclosure.

Operations of the chromatography unit 140, including running startup and purification recipes and batches, can be controlled by a system controller 110 (e.g., DeltaV™ PK Controller in combination with TruBio™ and/or TruChrom™ automation software architecture). Operation of one or more valves 144 in inlet/outlet manifolds 142, 154 can be controlled by an automated valve unit or manifold, and corresponding analog or digital input modules, transmitters, communication hubs, communication channels, and/or other communication devices for processing and exchanging data with the controller. An automated flow sensor 150 with analog or digital input modules, transmitters, communication hubs, communication channels, and/or other communication devices for processing and exchanging data with the controller can monitor and measure the flow rate and/or other fluid flow parameters of process liquids used in chromatography recipes. An automated air sensor 150 can monitor and measure concentration of air in process liquids or conduits used in chromatography recipes. Automated level sensors 150 can measure the liquid level in various chromatography unit components, such as a bubble trap 147.

System controller 110 described in greater detail hereafter may be communicatively configured in connection with the chromatography unit 140. As may be understood, this communicative configuration may occur in many forms. For instance, in one embodiment, the system controller 110 may be integrated directly with the chromatography unit 140. In another embodiment, the control system may instead be set up for remote control. Further, in at least one embodiment, the system controller 110 may be communicatively configured with the chromatography unit 140 through an intermediary controller, which may itself be configured to control chromatography unit 140. Such an intermediary controller may comprise, for instance, the DeltaV™ PK Controller in combination with TruBio™ and/or TruChrom™ automation software architecture; however, alternative intermediary controllers, whether owned and operated by some third-party or otherwise, are envisioned herein. Hence, in at least one embodiment, the system controller 110 disclosed herein may be configured to communicate with the intermediary controller, which may control the chromatography unit 140. Thus, the communicative configuration between the system controller 110 and the chromatography unit 140 herein may be direct, indirect, or some combination thereof.

In general, a purification recipe—alternatively referred to herein as a “recipe”—for a chromatography unit 140 comprises a set of instructions and/or steps given by a user to carry out the purification or isolation of a target component from a product on one or more separation matrices of chromatography unit 140. The creation of purification recipes may include editing, modifying, updating, resetting, and/or creating parameters for various components of the chromatography unit 140, including equipment sensors, valves, pumps, flow paths, and fluid transfer assemblies, raw materials, selecting inlet paths/manifolds for raw materials, selecting outlet paths/manifolds for products, product loading protocols, product elution protocols, changes in eluant or buffer solution concentration, and/or other parameters associated with peripherals and any other step or sub step related to chromatography purification process-collectively referred to herein as a one or more “step(s)”. Purification recipes can also include organizing, rearranging, prioritizing, and reprioritizing steps or sub-steps related to the chromatography purification process.

FIG. 1B is a front perspective view of an example chromatography system 100A in accordance with example embodiments. Chromatography system 100A includes column or column station 152A in fluid communication with inlet manifold unit 142A and outlet manifold 154A. Inlet manifold assembly 142A routes process liquids through chromatography system 100A. Further Inlet manifold assembly 142A can be coupled to fluid transfer assemblies 148A to route process liquids through chromatography system 100A. One or more pumps 144A secured in pump manifold alcoves 145A may be used to control the flow rate of process liquids through chromatography system 100A. Fluid transfer assemblies 148A including flow paths are designed to optimize or minimize hold-up volume, and sizes of individual fluid transfer assemblies 148A are matched to the flow rates with different capacities of single-use pump 144A. Thermo Scientific™ BioTitan™ Retention Device is included with all single-use transfer assemblies 148A in chromatography system 100A. The retention device mainly enhances the overall reliability and integrity of the fluid transfer assemblies by minimizing the risk of leaks and failures at the connection points in fluid transfer assemblies 148A. Further, the fluid transfer assemblies 148A are gamma-sterilized to minimize the risk of contamination.

Generally, flow paths in fluid transfer assemblies 148A are verified for chemical compatibility and resistance to commonly used solvents and solutions including water for injection (WFI), ambient water for injection (AWFI), buffer solutions, and/or product load. One common example of a buffer used as an eluting fluid is 50 mM acetic acid. Other buffers can also be used. Examples of washing fluids can include phosphate and NaCl solutions, more specifically, 50 mM phosphate and 500 mM NaCl. Other fluids, such as buffers that will not detrimentally alter the matrix material, can also be used. Other examples of buffer solutions include a single component or a combination of components, comprising acetic acid, BIS-TRIS, citric acid, ethanol, HEPES, MES, sodium acetate, sodium chloride, sodium hydroxide, sodium phosphate, Tris, Ambient water for Injection, glycine, phosphoric acid, sodium citrate, benzyl alcohol, or formic acid.

A bubble trap 147A secured in a bubble trap alcove 149A can be used to reduce the amount of air from contacting column 152A during the flow of process fluids (e.g., buffer solutions, injected water, feed streams, or product streams) in the chromatography system 100A. Bubble trap 147A can efficiently trap air from different sources, air entrapped in the process fluid, air sucked into the system due to improperly fixed fitting, a dry line condition, a leak, or other conditions. Proximity sensors or level sensors (not seen in FIG. 1B), such as ultrasonic sensors, measure, monitor, and control the presence and/or height of liquid (e.g., buffer solution) flowing through bubble trap 147A, which can be affected by air bubbles in the liquid.

One or more sensors 150A, 150B can be coupled to fluid transfer assemblies 148A to monitor the process liquids flowing through chromatography system 100A. Sensors can be disposed of at pre-column sensor 150A (upstream) and/or post-column sensor 150B (downstream) positions. Sensor 150A positioned prior to column station 152 or at pre-column positions are configured to measure process liquid parameters before the process liquid enters column station 152. In the example depicted, sensor 150A can include an air sensor and sensor 150B can include a flow sensor. Sensors 150B disposed at post-column positions are configured to measure buffer solution, injected water, feed stream, or product stream parameters and identify target molecules isolated and carried in the buffer solution after they exit the chromatography station 152.

In example, embodiments, sensors 150A, 150B can include one or more sensors that can measure parameters of a fluid or system, including temperature sensors, pressure sensors, mass flow controllers, air sensors, digital pH transmitters, conductivity sensors, turbidity sensors, digital dissolved oxygen transmitters, pH sensors, dissolved oxygen sensors, resistance temperature detectors, proximity sensors, level sensors, thermocouple temperature detectors, or any other sensor for measuring process fluid properties and/or system parameters.

A user can control the operations of chromatography system 100A via a user interface 162A displayed on user workstation 160A. User interface 162A can include user inputs and readable instrument and process parameter outputs for controlling and monitoring chromatography system 100A through the system controller 110. In at least one embodiment, such a user interface 162A can include a panel consisting of two medical-grade touchscreen monitors 163A that is attached to a moveable arm 165A, along with a keyboard 167A for inputting values and monitoring the purification processes in chromatography system 100A.

Chromatography system 100A can include auxiliary or miscellaneous accessories including an alarm light 158A, extra auxiliary connections 158B, leveling feet 158C, center handle 158D, and casters 158E. Alarm light can be disposed of at the top of the chromatography system 100A, as shown in FIG. 1B, and can be folded flat for easier transportation. Further user-specified parameters as part of the alarm component 155 can be set to activate visual alarms on alarm light 158A upon detection of malfunction or one or more components of the chromatography system 100A. Auxiliary connections 158B can be used as a standby for use in case of failure with fluid transfer assemblies 148A. While leveling feet 158C can be used for leveling the chromatography unit on base flooring, handle 158D and casters 158E aid in moving chromatography system 100A between various positions on base flooring.

FIG. 1C depicts a block diagram of a user workstation 160 of at least one embodiment of the present invention. In at least one embodiment, such a user workstation 160 may comprise a computing device, such as a computer or some other smart device, that can perform some or all operations of an automated chromatography system, user computing device(s), processing unit(s) and/or controller(s) in accordance with the example embodiments. The example chromatography system(s) 100, system controller(s) 110, including its controllers, modules, libraries, and data repositories, disclosed herein can include or be implemented by one or more computing devices. In some embodiments, the example user workstation 160 may comprise a single computing device or multiple computing devices. Further, as discussed below, such a user workstation 160 that implements the example automated chromatography control systems, modules, data repositories, and libraries can be part of one or more chromatography units 140, processors 112 and system controllers 110, a user's local computing device, a service provider's local computing device, or a remote computing device. User workstation 160, and various interconnected processor(s) or processing units 112 and system controllers 110, can also be contained in a unitary computing system or server with a user interface or distributed over servers and systems.

The user workstation 160 depicted in FIG. 1A may comprise a number of components; however, it may be understood at least some of such components may be omitted or duplicated, as suitable for the application and setting. In some embodiments, some or all of the components included in the user workstation 160 can be attached to one or more motherboards and enclosed in a housing (e.g., including plastic, metal, and/or other materials). In some embodiments, some of these components may be fabricated onto a single system-on-a-chip (SoC) (e.g., a SoC may include one or more processing devices 164 and one or more storage devices 168). Additionally, in various embodiments, the user workstation 160 may not include one or more of the components illustrated in FIG. 1C, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 600 may not include a display device 162, but may include display device interface circuitry (e.g., a connector and driver circuitry) to which a display device 162 may be coupled.

The user workstation 160 can include a processing medium or device 164 (e.g., one or more processing devices). As used herein, the term “processing device” refers to any device or portion of a device that processes electronic data from registers and/or memory to transform that electronic data into other electronic data that may be stored in registers and/or memory. The processing device 164 can include one or more digital signal processors (DSPs), application-specific integrated circuits (ASICs), central processing units (CPUs), graphics processing units (GPUs), crypto processors (specialized processors that execute cryptography algorithms within hardware), server processors, or any other suitable processing devices.

The user workstation 160 can also include a storage device 168 (e.g., one or more storage devices). The storage device 168 can include one or more memory devices such as random-access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 168 can include memory that shares a die with a processing device 164. In such an embodiment, the memory can be used as cache memory and can include embedded dynamic random-access memory (eDRAM) or spin transfer torque magnetic random-access memory (STT-MRAM), for example. In some embodiments, the storage device 168 can include non-transitory computer-readable media having instructions thereon that, when executed by one or more processing devices (e.g., the processing device 164), cause the user workstation 160 to perform any appropriate ones of or portions of the methods and operations disclosed herein.

The user workstation 160 can include an interface device 170 (e.g., one or more interface devices 170). The interface device 170 can include one or more communication chips, connectors, and/or other hardware and software to govern communications between the user workstation 160 and other computing devices. For example, the interface device 170 can include circuitry for managing wireless communications for the transfer of data to and from the user workstation 160. The term “wireless” and its derivatives are used to describe circuits, devices, systems, methods, techniques, communications channels, etc., that can communicate data through the use of modulated electromagnetic radiation through a nonsolid medium. The term does not imply that the associated devices do not contain any wires, although in some embodiments they might not. Circuitry included in the interface device 170 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some embodiments, circuitry included in the interface device 170 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 170 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 606 for managing wireless communications can operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 170 can include one or more antennas (e.g., one or more antenna arrays) to receive and/or transmission of wireless communications.

In some embodiments, the interface device 170 can include circuitry for managing wired communications, such as electrical, optical, or any other suitable communication protocols. For example, the interface device 170 can include circuitry to support communications in accordance with Ethernet technologies. In some embodiments, the interface device 170 can support both wireless and wired communication and/or may support multiple wired communication protocols and/or multiple wireless communication protocols. For example, a first set of circuitries of the interface device 170 can be dedicated to shorter-range wireless communications such as Wi-Fi or Bluetooth, and a second set of circuitries of the interface device 170 can be dedicated to longer-range wireless communications such as global positioning system (GPS), EDGE, GPRS, CDMA, WiMAX, LTE, EV-DO, or others. In some embodiments, a first set of circuitries of the interface device 606 can be dedicated to wireless communications, and a second set of circuitries of the interface device 406 can be dedicated to wired communications.

The user workstation 160 can include battery/power circuitry 166. The battery/power circuitry 166 can include one or more energy storage devices (e.g., batteries or capacitors) and/or circuitry for coupling components of the computing device 600 to an energy source separate from the user workstation 160 (e.g., AC line power).

The user workstation 160 can include a display device 162 (e.g., multiple display devices). The display device 162 can include any visual indicators, such as a heads-up display, a computer monitor, a projector, a touchscreen display, a liquid crystal display (LCD), a light-emitting diode display, or a flat panel display.

The user workstation 160 can include other input/output (I/O) devices 172. The other I/O devices 172 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the user workstation 160, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The user workstation 160 can have any suitable form factor for its application and setting, such as a handheld or mobile computing device (e.g., a cell phone, a smartphone, a mobile internet device, a tablet computer, a laptop computer, a netbook computer, an Ultrabook computer, a personal digital assistant (PDA), an ultra-mobile personal computer, etc.), a desktop computing device, or a server computing device or other networked computing component.

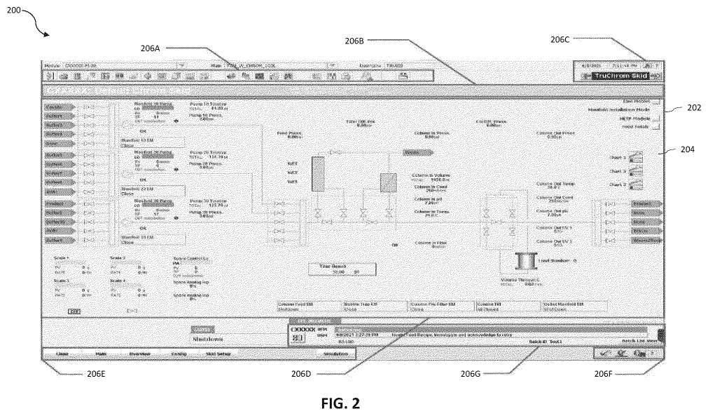

FIG. 2 is a user interface displayed on a client computing device or user workstation 160 in accordance with example embodiments. In general, the user interface or main screen 200 is an example of user interface 162 that can be displayed at user workstation 160 (shown in FIG. 1A). User interface 200 displays buttons and dynamos (control modules), which can be used by the user for controlling chromatography unit 140 for a purification process of a target component of interest. User interface 200 can include a screen and display 202 (touch screen/display or other physical input) and a graphical user interface 204 with one or more primary selection areas 206A-G. The first selection area or toolbar 206A provides quick access to different features including Exit, print, Control Module, Detail Screen, Display Screen, Display Directory, Reset, Graphic Select, Return, Main Overview, Alarm Summary, alarm filters, DeltaV Utilities, DeltaV Log-On, Diagnostics. Process History View, Chart Builder, Batch History View, Batch Operator Interface, Application Toggle, Tag Search utility, and Tag Toggle. The second selection area or chromatography information banner 206B displays the system type and product or equipment number of chromatography unit 140 in use. Additionally, when a Save File has been loaded the type of file and the date loaded is also displayed. Third selection area or controller identification box 206C identifies equipment information about chromatography unit 140 in use. Controller identification box 206C also provides a form to select from a drop-down list of all of the chromatography units available or set up for use.

The fourth selection area or main system graphic screen 206D shows the different control and equipment modules that control the flow of process fluids through chromatography unit 140. The main system graphic screen 206D provides access to the faceplates of the control module, which contain options for controlling ancillary components (e.g. pumps, sensors, fluid transfer assemblies and flow paths). In other words, main system graphic screen 206D provides the user with access to different control modules and faceplates, including Valve Controller faceplate, Flow Controller faceplate, Totalizer faceplate, Pressure Meter faceplate, Digital Input (DI) faceplate, Inlet Pressure faceplate, Pre-Column Difference Pressure faceplate, Power Supply alarm, UPS Alarm, Optek failure alarm, AWFI available alarm, Operator note, Bubble trap, Column, Column inlet total faceplate, Column inlet conductivity faceplate, Column inlet pH faceplate, Column inlet temperature faceplate, Column inlet flow faceplate, Column differential pressure faceplate, Column outlet temperature faceplate, Column outlet conductivity faceplate, Column outlet pH faceplate, Column outlet UV faceplate, Column total faceplate, Tare Meters faceplate, Manifold Installation Mode faceplate, HETP Module faceplate, and Feed Totals faceplate. Additionally, the main system graphic screen 206D provides access to different equipment modules and faceplates, including the Manifold EM faceplate, Column Feed EM faceplate, Bubble Trap EM faceplate, Column Pre-Filter EM faceplate, Column EM faceplate, and Outlet Manifold EM faceplate. Each control module faceplate provides access to most tuning parameters and diagnostic information for the chromatography unit 140. It allows the user to monitor and/or control various configurable parameters i.e. limits, tuning, alarms, gain scheduling, diagnostic, input types, interlocks, and calibration functions. Similarly, each equipment module face plate also provides access to tuning parameters including alarms, failure monitors, parameters, malfunction detectors, and diagnostics.

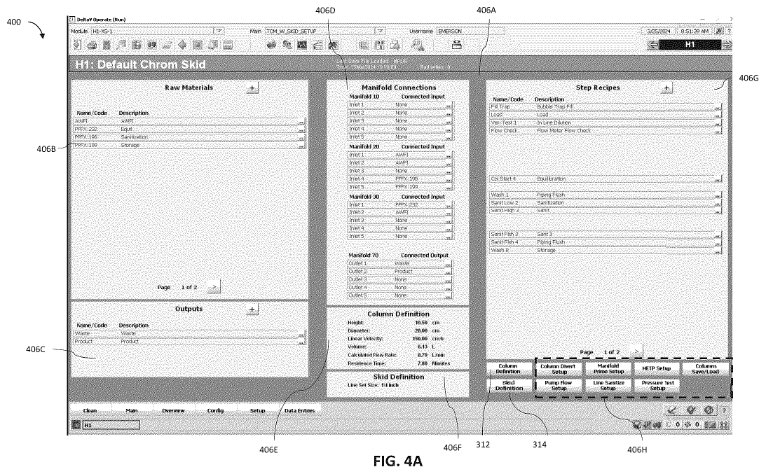

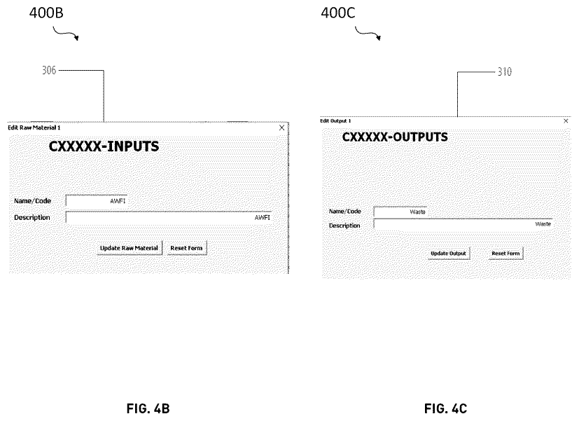

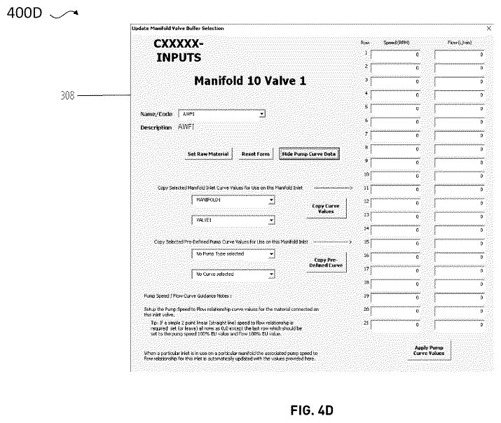

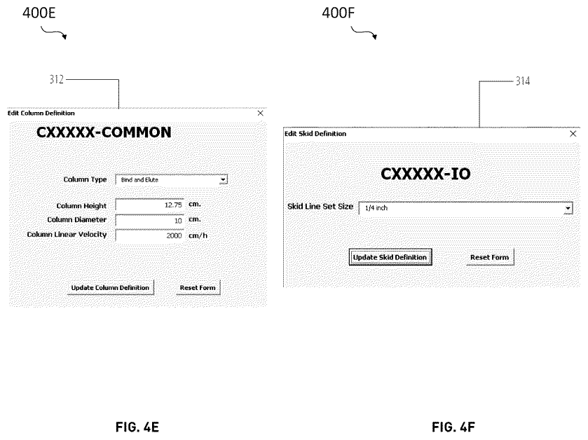

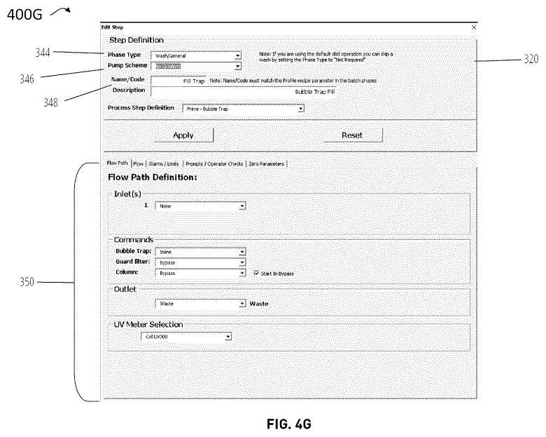

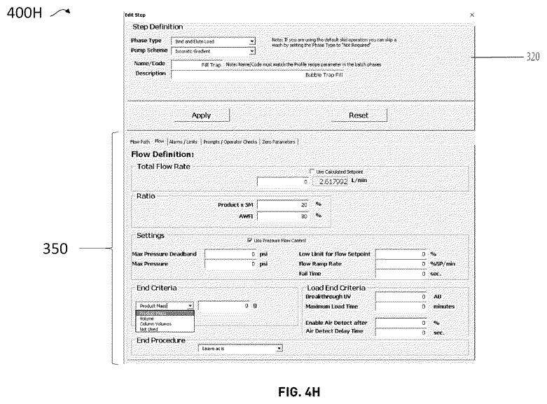

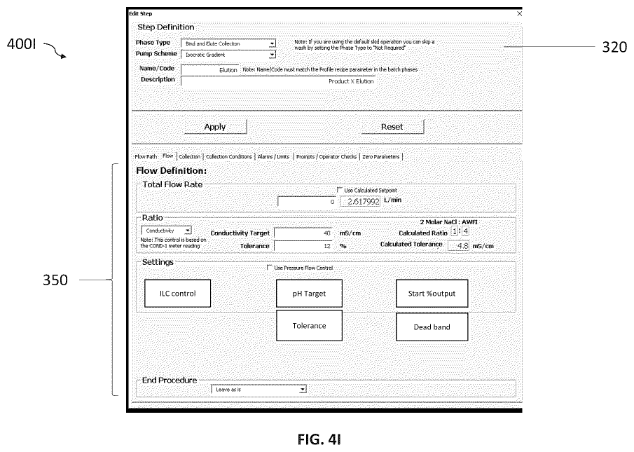

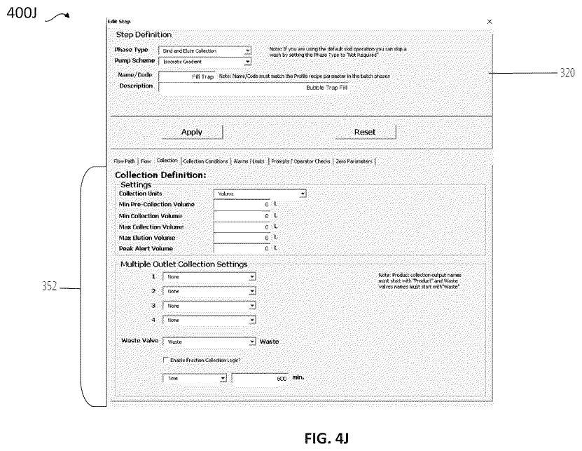

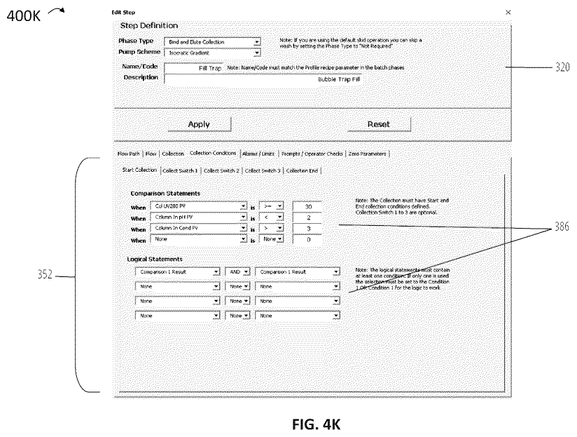

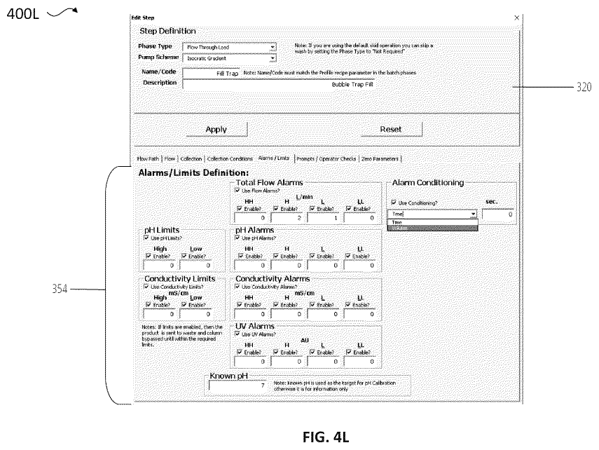

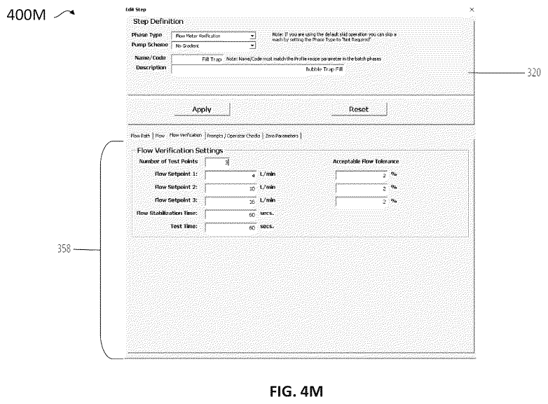

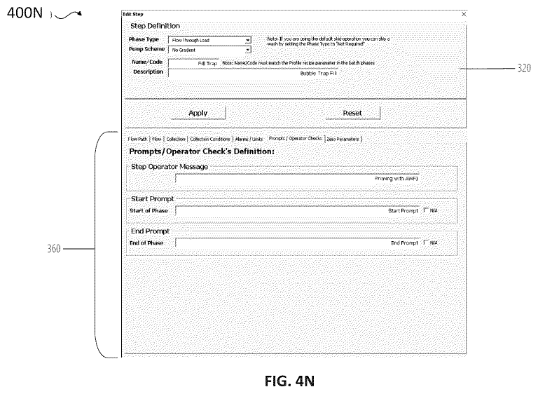

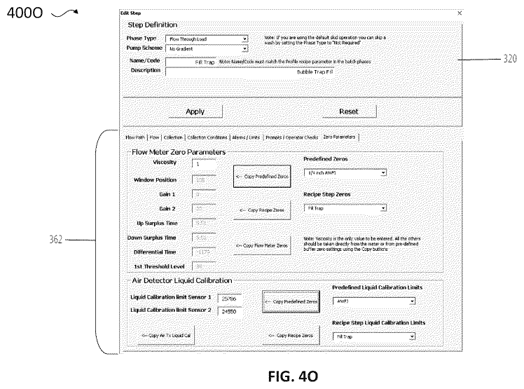

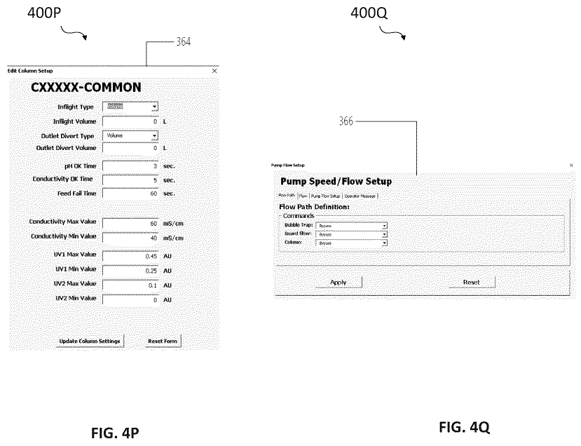

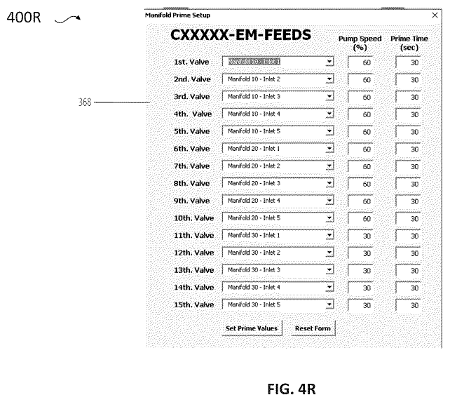

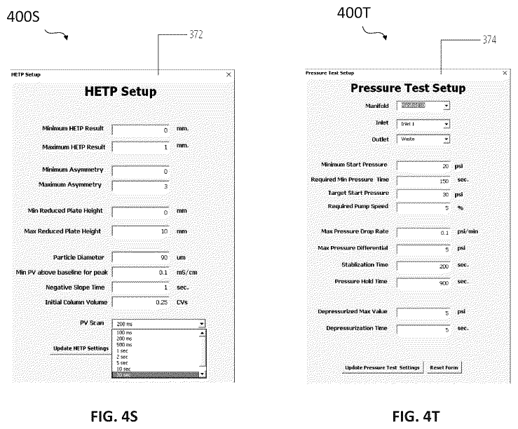

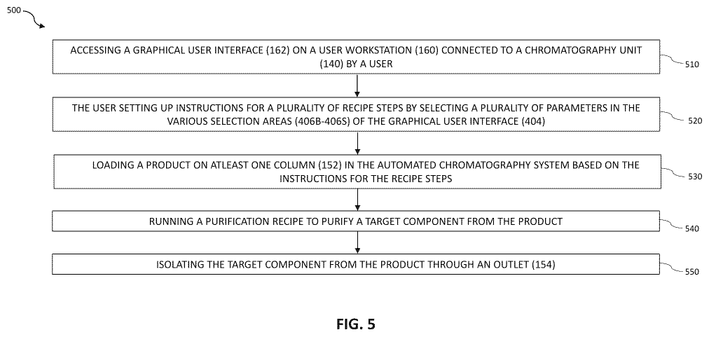

The fifth selection area or navigation buttons toolbar 206E provides access to different screens including a clean, main, overview, configuration, and skid setup screens. Specifically, the skid setup screen option provides access to secondary selection areas comprising at least one secondary virtual output as discussed in detail below (See description related to FIG. 4A to FIG. 4Q). Sixth selection area or toolbar 206F provides access to control buttons for alarms and also provide communication status information. Seventh selection area or Batch Operator Interface 206G provide user access to create, modify, and start a batch recipe in chromatography unit 140. The batch operator interface has various options including adding, removing, rebinding, starting, restarting, holding, resetting, automating, manually running, commenting, providing status, and aborting a batch recipe. To further optimize and facilitate automation of operations of chromatography unit 140, all the data entered, edited, modified, or updated, in the above user interface 204 or in the below graphical user interface 404, is processed by processor 112, and securely stored in one or more modules, components, segments, and the like, in memory 114.

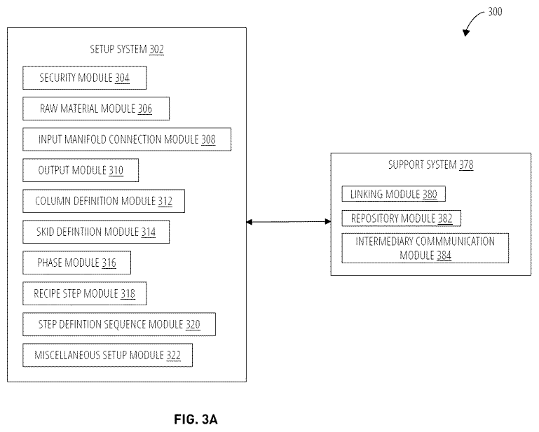

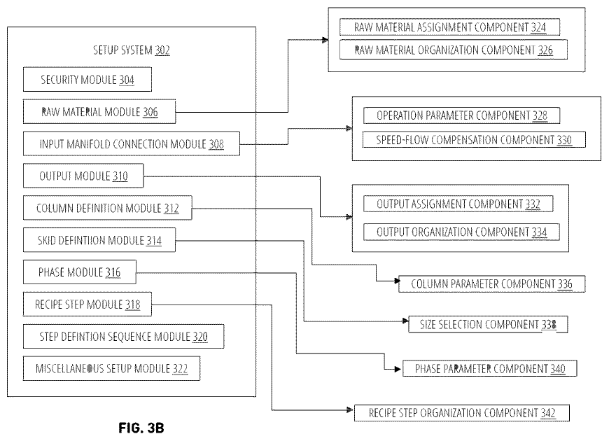

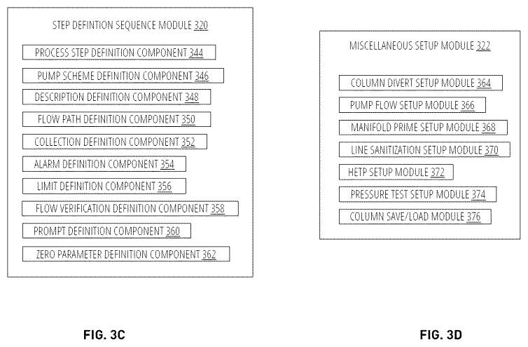

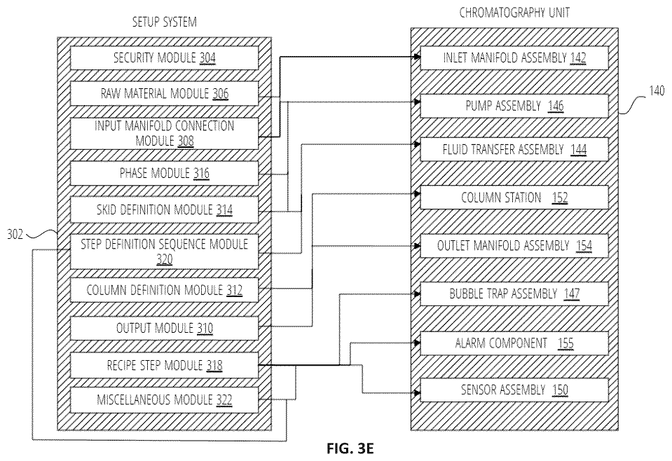

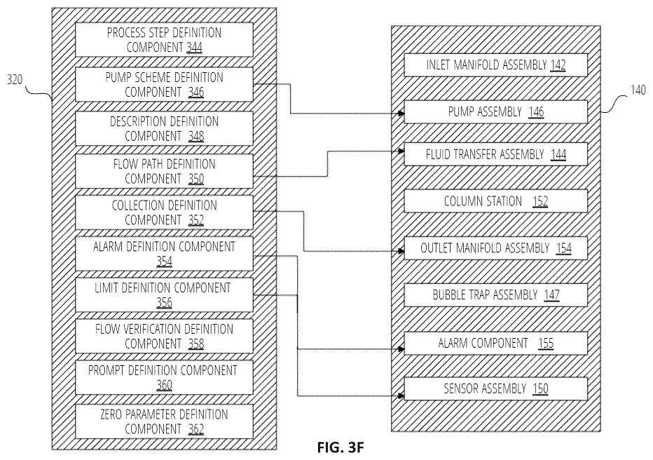

In general, FIG. 3A to FIG. 3F illustrate schematic diagrams of at least one embodiment of a control system 300 to be used in connection with a chromatography unit 140. In one or more embodiments of the present invention, such a control system 300 may be operable by the system controller 110, such as by being stored in the memory 114 and configured for operation by the processor 112 thereof. Alternatively, such a control system 300 may be operable by such system controller 110 via one or more cloud-based computing networks. Such a control system 300 may generally be configured to define, such as by one or more inputs received by the system controller 110 from the user workstation 160, at least one recipe, as well as any steps thereof, to be performed by the chromatography unit 140. Hence, the control system 300 defines how the system controller 110 interacts with the chromatography unit 140.

At least one embodiment of such a control system 300 may be seen in FIG. 3A, which depicts a setup system 302 communicatively configured in connection with a support system 378. In at least one embodiment, such a setup system 302 may comprise a plurality of modules configured to enable a user to create, edit, and/or initiate a purification recipe for use by the interlinked chromatography unit 140. Such a support system 378, in contrast, may comprise certain modules configured to enable the processes, functions, and/or procedures provided by the various modules of the setup system 302. For instance, the repository module 382 of the support system may be used to store the purification recipe, and the various steps therefor, while likewise displaying the same to a user upon request for the editing thereof. Likewise, the linking module 380 of the support system 378 may be configured such that the setup system 302 is appropriately updated whenever a user inputs and/or edits any data associated with one of the modules thereof. As such, it may be understood the setup system 302 and the support system 378, in at least one embodiment of the present invention, are communicatively interlinked. However, it may be understood the setup system 302 of at least one embodiment of the present invention may be configured so as to function without the communicative interlinkage with a support system 378. Further, setup system 302 can be configured in read/write relation with support system 378, and support system 378 including a repository module configured to store at least one step of a recipe.

With continued reference to FIG. 3A, it may be seen the setup system 302 of at least one embodiment of the present invention may comprise a plurality of modules, namely: a security module 304, a raw material module 306, an input manifold connection module 308, an output module 310, a column definition module 312, a skid definition module 314, a phase module 316, a recipe step module 318, a step definition sequence module 320, and miscellaneous module 322. Some and/or all of such various modules 304-322 of which the setup system 302 is comprised may themselves comprise a database or library of information that can be stored in memory 114 of the system controller 110, through which a user may perform functions relating to the creation of a purification recipe via the user interface device 162 of the user workstation 160, as recited in greater detail heretofore. As discussed above, the data stored in memory 114 relating to such various modules and components 304-322 can be recalled, edited, modified, and organized, through the various modules in support system 378.

Security module 304 of setup system 302 includes informational data relating to the provision of access to setup system 302, thereby providing secure control over the operation of the chromatography unit 140. Such a security module 304 may be configured to provide and/or restrict access to various recipe steps, such as to change, edit, update, modify or reset a parameter associated therewith, dependent on the user identity provided while logging into user workstation 160. As may be understood, such level of access/restriction may be automatically provided depending on, for instance, the information associated with the credentials of the user at issue, such as their seniority, hierarchical placement within the organization, specialization, or otherwise. Alternatively, the user workstation 160 can be manually configured to set the access level at which the recipe steps can be added or edited by a particular user based on his/her user identity. Further, such a security module 304 may be configured in connection with one or more chromatography unit 140 interconnected with workstation 160 in such a manner so as to provide different access levels for each distinct chromatography unit 140. In at least one embodiment, when a user requests login into user workstation 160, the associated credentials for such user are processed within the security module 304 to determine the level of access afforded to such user. In at least one embodiment, the resulting level of access provided to such users may be communicated to them via the user interface 200 of the user workstation 160.

With reference to FIG. 3B, the raw material module 306 of at least one embodiment of the setup system 302 may be configured to enable a user to insert informational data related to the raw materials to be used in a given purification recipe. For instance, a user may utilize a raw material assignment component 324 to assign a given raw material to be used in the purification recipe at issue. In at least one embodiment, such a raw material assignment component 324 may be configured to display a list of raw materials associated with a chromatography unit 140, such as those previously used in purification recipes performed at such chromatography unit 140. In at least one embodiment, such a raw material module 306 may also be configured to check for already existing raw materials when a user attempts to reenter the same raw material, and flag and/or generate an error message in such an instance. Put simply, the raw material module 306 of at least one embodiment of the present invention maintains a list of all existing raw materials. In conjunction therewith, a user may utilize the raw material organization component 326 to view, delete, or edit existing raw materials.

The input manifold connection module 308 of at least one embodiment of the setup system 302 may be configured to enable a user to adjust the operation of the inlet manifold assembly 142 of the chromatography unit 140. More specifically, the input manifold connection module 308 is configured to associate the raw material(s) input by the user via the raw material module 306 and assign the same to the respective inlet manifold(s) for the purification recipe at issue. In other words, the user may dictate which raw material flows into the chromatography unit 140 through which manifold for capture and further use through the input manifold connection module 308. For instance, in at least one embodiment, such an input manifold connection module 308 may comprise an operational parameter component 328 and speed flow compensation component 330. Such an operational parameter component 328 stores information regarding operation parameters, like the selection of a specific raw material for a specific manifold, sequence of operations for the manifold, and operation of valves and pumps associated with the manifold, the speed flow compensation component 330 stores data related to the flow rate of buffer solutions in input manifolds.

Likewise, in the output module 310 of setup system 302 at least one embodiment of the present invention may be configured for the user selection of output-related information for the purification recipe. Specifically, output module 310 may store all information regarding fluid flowing out of the outlet of chromatography unit 140. For example, the fluid flowing through can be waste, product, byproducts separated from the product during the purification step, and impurities. As such, output module 310 may be configured to enable a user to assign output-related information—i.e., output detail(s)—for the raw material input by the user via the raw material module 306 through an output assignment component 332. Such an output assignment component 332 may further be configured to receive information relating to the name and/or description of such output(s). Output module 310 is also configured to check for already existing output names when a user attempts to reenter the same output name and flag an error message. Effectively, output module 310 maintains a list of all output, with updates on deleted or newly added raw materials. As with the raw material module 306, such an output module 310 may further comprise an output organization component 334, through which a user may view, delete, or edit existing output information.

Column definition module 312 of at least one embodiment of the setup system 302 may be configured to enable a user to input selections relating to the column definition details for operating the chromatography unit 140. For instance, column definition module 312 may receive information related to column specifications parameters including, height, diameter, volume, linear velocity, residence time, and minimum and maximum values for peak identification, all of which may be input by a user through a column parameter component 336.

Similarly, the skid definition module 314 of various embodiments of the setup system 302 may be configured to receive skid details relating to the operation of chromatography unit 140. Skid definition module 314 stores information related to skid specifications parameters including, without limitation, skid line set sizes, which may be input by a user through the size selection component 338.

Another module of at least one embodiment of the setup system 302 of the present invention is phase module 316, which is configured for the user selection of phase details for the purification recipe at issue. Phase module 316 stores information related to phase details including elution, flow verify, flowthrough, load, and skid feed, all of which may be input by a user through the phase parameter component 340.

Recipe step module 318 of at least one embodiment of the setup system 302 may be configured for the user input of recipe step details for operating the chromatography unit 140. More specifically, the recipe step module 318 enables a user to perform one or more recipe functions relating to the details of various steps of the purification recipe through a recipe step organization component 342, such as including new steps to the recipe, changing various aspects of existing steps, listing all available steps, and organizing set of the same.

The step definition sequence module 320 of various embodiments of the setup system 302 may be configured for the input of step definition details for operating chromatography unit 140. In other words, the step definition sequence module 320, and the various components thereof, is configured to enable a user to input and/or define one or more steps of one or more recipes. As depicted in FIG. 3C, the step definition sequence module 320 may comprise a variety of components configured to enable the precise selection of a variety of aspects associated with the purification recipe to be used in connection with the chromatography unit 140. For instance, such a step definitions sequence module 320 may comprise a process step definition component 344, pump scheme definition component 346, and description definition component 348, all of which may collectively enable a user to input information and/or make selections relating to, for instance: the process step type, including the wash protocol, the bind and elute load, the bind and elute collection, the flow through load, the flow through post load chase, the pump functions during no gradient, isocratic gradient, and linear gradient, and description to be associated with the given step of the purification recipe.

More particularly, such a process step definition component 344 may be configured to define one or more process step selections, such as the phase type and/or the process step itself, whether that be priming the bubble trap 147 of the chromatography unit 140 or otherwise, for a given step of a recipe. The pump scheme definition component 346 may be configured to define one or more pump scheme selections, such as the application of any gradients for the pump(s) 144 of the chromatography unit 140. The description definition component 348, meanwhile, may be configured to define one or more definition selections to the step of the recipe, such as name, code, or description used to identify the step at issue.

Likewise, at least one embodiment of the step definition sequence module 320 may comprise a flow path definition component 350, through which a user may define a flow path selection, such as the flow path for fluids during the execution of the purification recipe at issue, and a collection definition component 352, which may be used to define one or more collection selections, such as by defining various settings relating to the collection functions to be performed by the purification recipe—e.g., selecting the units for collection parameters and the product outlets to be used. Further, the alarm definition component 354 and limit definition component 356 may be collectively used to define the generation of alarms—i.e., an alarm selection—based on appropriate thresholds—i.e., a limit selection—for various parameters for chromatography unit 140 components including pumps 144, valves 146, bubble trap 147, sensors 150, column 152, outlet 154.

The step definition sequence module 320 of various embodiments of the present invention may comprise additional components. For instance, a flow verification component 358 defines flow verification selections, such as by storing data related to the verification of flow rates during the running of a purification recipe. The data related to flow verification component 358 is updated each time a user changes the flow path definition through user interface 406L described later. Prompt definition component 360 defines prompt selections, such as by storing data related to the generation of prompts during the running of a purification recipe. The data related to prompt definition component 360 is updated each time a user changes the flow path definition through user interface 406M described later. Zero parameter definition component 362 enables the provision of zero parameters for various component measurements (for example flow sensors, air sensors) of the chromatography unit 140 while running the purification recipe at issue, such as by defining zero parameter selections therefor.

The miscellaneous module 322 of at least one embodiment of setup system 302 may include a plurality of modules through which a user may specify miscellaneous data for operating chromatography unit 140. For example, such a miscellaneous module 322 may comprise: (a) a column divert setup module 364, which may be configured to define parameters relating to the column station 152—i.e., diversion selection(s); (b) a pump flow setup module 366, which may be configured to define parameters relating to pump flow and flow path—i.e., pump flow selection(s); (c) a manifold prime setup module 368, which may be configured to define parameters relating to equipment module feeds in relation to the valves 146—i.e., priming selection(s); (d) a line sanitization setup module 370, which may be configured to define parameters relating to the sanitization processes for the chromatography unit 140—i.e., sanitization selection(s); (e) an HETP setup module 372, which may be configured to define parameters relating to volume qualification including HETP results—i.e., HETP selection(s); (f) a pressure test setup module 374, which may be configured to define parameters relating to pressures for the inlet manifold 142 and the outlet manifold 154—i.e., pressure test selection(s); and (g) a column save/load module 376, which may be configured to store recipe steps and/or other data defined through the setup system 302 into the support system 378 and/or the repository module 382 thereof.

Referring to FIG. 3A to FIG. 3F, and in particular 3E to FIG. 3F, it may be understood the recipe data generated through the various modules and components of the setup system 302 facilitate the various operations performed by the components of the chromatography unit 140. In other words, the setup system 302 can, by virtue of the modules and/or components thereof, can store-and-recall, edit, or newly formulate one or more purification recipes, including the operational steps and parameter settings enabling the system controller 110 to control and automate equipment (e.g., pumps, valves, sensors, bubble traps, column temperature, flow rates) in the chromatography unit 140, (e.g., shown in FIG. 1A).

For example, data included in security module 304 can restrict user access to chromatography unit 140. The system controller 110 can recall data in security module through communication link 118 or linking module 380 or intermediary communication module 384 to check on authentication and access levels for users based on their user identity. Similarly, the operations of the various other assemblies, stations, and/or components of the chromatography unit 140 may be facilitated as follows: (a) the inlet manifold assembly 142 may be facilitated by the raw material module 306 and the input manifold connection module 308; (b) the pump assembly 146 may be facilitated by the raw material module 306, the input manifold connection module 308, the phase module 316, and the skid definition sequence module 320; (c) the fluid transfer assembly 144 may be facilitated by the skid definition module 314, and the step definition sequence module 320; (d) the column station 152 may be facilitated by the column definition module 312 and the output module 310; (c) the outlet manifold assembly 154 may be facilitated by the column definition module 312 and the output module 310; (f) the bubble trap assembly 147, the alarm component 155, and the sensor assembly 150 may all be facilitated by the step definition sequence module 320, the recipe step module 318, and the miscellaneous module 322. As may be understood, the foregoing manner in which the various modules and/or components of the setup system 302 interact with the assemblies, stations, and/or components of the chromatography unit 140 is merely exemplary, and alternative interactions and/or facilitations between the setup system 302 and the chromatography unit 140 are envisioned herein.

Likewise, as depicted in FIG. 3F, data generated through the pump scheme definition component 346 and flow path definition component 348 can be used to facilitate operations of pump assembly 146 and/or fluid transfer assembly 144. The data generated through the collection definition component 352 may likewise facilitate the operations of the outlet manifold assembly 154. And the data generated through the alarm definition component 354 and limit definition component 356 may facilitate the operations of the sensor assembly 150 and alarm component 155. As may be understood, various embodiments of the present invention disclosed herein envision the use of one or more combinations of different modules and the associated components of setup system 302, other than those described above, to monitor, control, and facilitate operations of the various components of chromatography unit 140.

In general, FIG. 4A to FIG. 4Q illustrate exemplary user interface(s) 400 for the control system 300 described heretofore. Such user interface(s) 400 may be displayed on at least one user workstation 160, such as the one depicted in FIG. 1, through the display device 162 thereof, and may be disposed in input-output communication with at least one processing device 164 thereof. As may be understood, various embodiments of user interface(s) 400 may enable an operator and/or user to view, select, edit, or otherwise configure at least one purification recipe to be used in connection with a chromatography unit 140 via the various modules of the setup system 302. Accordingly, it may be understood such user interface(s) may enable the configuration of a plurality of parameters necessary for the formation of a purification recipe including, without limitation, selecting the raw materials fed into the chromatography unit 140, process liquids used, equipment setup parameters, output parameters, manifold and fluid flow path parameters, column parameters, line set sizes, and different startup and purification recipe steps.

Specifically, in at least one embodiment, the user interface 400 can be used to define one or more steps and/or sub-steps in a startup or purification recipe of interest. For instance, such a user interface 400 can be provided on a display device 162 (touch screen/display or other physical input) and a graphical user interface 406A may comprise one or more selection areas comprising at least one secondary virtual output configured to operate the various modules and/or components of the setup system 302, including, without limitation: (i) raw material module 306; (ii) input manifold connection module 308; (iii) output module 310; (iv) column definition module 312; (v) skid definition module 314; (vi) phase module 316; (vii) recipe step module 318; (viii) step definition sequence module 320; and/or (ix) miscellaneous setup module 322. Graphical user interface 406A is also known as the Skid setup screen and can be accessed by selecting “Skid Setup’ on the navigation toolbar 206E illustrated in FIG. 2 described earlier.

Selection area 406B of at least one embodiment of user interface 400 may be configured in connection with raw material module 306 and may therefore display virtual input/output controls related to the selection of raw materials for a startup or purification recipe on chromatography unit 140. For example, selection area 406B may display a liquid of “Ambient water for Injection (AWFI)” and a dropdown menu list enabling a user to select other liquids and buffers of interest to flow through a chromatography unit (e.g., chromatography unit 140). Upon accessing the ‘+’ icon in selection area 406B, a user interface window 400B for adding or editing raw material information, which will subsequently be displayed within the selection area 406B.

For instance, as depicted in FIG. 4B, user interface window 400B may include options for providing Name/Code, and Description for raw material, updating the raw material data with new data entered, and a reset form option for erasing or deleting the currently entered data. In other words, different types of data can be modified by a user via user interface window 400B, including: (i) adding raw material code parameters to store the short name for the raw material; (ii) adding a raw material description to the raw material code; and (iii) deleting, editing or viewing a list of all raw materials. Optionally, a 12-character limit can exist for the raw material name and a 50-character limit for the raw material code. As may be understood, similar character limits may be imposed for other data input through user interface window 400B, or other such user interface windows discussed herein. Further, processor 112 can perform a check to confirm that any new raw materials added do not already exist in the list of raw materials, such as through the interconnection with the repository module 382 of the support system 378. If a new raw material fails to clear the test, an error message can be given to the user to inform the user of the conflict and the new addition can be rejected. In some examples processor 112 can set a maximum limit (for example: a maximum of 40 raw materials) for the number of raw materials that can be added for a particular chromatography unit 140.

Returning to FIG. 4A, selection area 406C may, in at least one embodiment, be configured in connection with the output module 308, and may therefore display virtual output controls related to outputs for startup or purification recipes on chromatography unit 140. For example, selection area 406C may display outputs indicating a product from a 500 L Single Use Mixer and a Waste output from the chromatography unit 140. Upon accessing the ‘+’ icon in Selection area 406C, a user interface window 400C for defining output parameters is displayed as shown in FIG. 4C. User interface window 400C includes options for providing Name/Code and Description for output parameters, updating the output parameters with new data entered by the user, and a reset form option for erasing or deleting the currently entered data. In other words, different types of data that can be modified by a user by using user interface window 400C include: (i) adding an output parameter to store the short name for the output; (ii) adding an output description to the output code; and (iii) deleting, editing or viewing a list of all outputs. Further, processor 112 can perform checks to confirm any output data newly added does not already exist in the list of outputs, such as through interconnection with the repository module 382 of the support system 378 as recited in greater detail heretofore. If new output data fails to clear the test, an error message can be given to the user to inform the user of the conflict and the new addition can be rejected. In some embodiments, processor 112 can set a maximum limit (for example: a maximum of five outputs) for the number of outputs that can be added for any particular chromatography unit 140 or set thereof.

With continued reference to FIG. 4A, selection area 406D of at least one embodiment of the present invention may be interconnected with the manifold connection module 308 and may therefore enable a user to select and set inlet/outlet manifold connections with a source of liquid (e.g., buffer solution of interest, injected water, feed stream, product stream, or waste stream). For example, inlet 1 of manifold 20 includes a fluid connection to an AWFI, whereas outlet 1 of manifold 70 includes a waste stream, and outlet 2 of manifold 70 includes a fluid connection to a product stream. Thus, by interacting with selection area 406D, a user interface 400D for choosing an inlet manifold for raw materials may be provided, as shown in FIG. 4D. As shown, user interface 400D may include options for providing a Name/Code and description for one more manifold associated with their respective valves, as well as various drop down lists and fillable fields to configure, for instance, a pump speed to flow relationship for a given manifold.

Selection areas 406E and 406F, as shown in the embodiment depicted in FIG. 4A, may be interconnected with the column definition module 312 and skid definition module 314, respectively, and may therefore display data related to the chromatography column (Height, Diameter, Linear Velocity, Volume, Calculated Flow rate, Residence time, etc.) and skid definition (Line-set size), respectively. Upon accessing selection area 406E, a user interface window 400E for viewing column-related data may be provided, as shown in FIG. 4E. As depicted therein, user interface window 400E may provide options for the user to update, modify, and/or reset data related to the column employed in the chromatography unit 140, including, without limitation, defining the height, diameter, volume, linear velocity. Similarly, selection area 406F may provide options for the user to view data related to chromatography unit 140. Upon accessing selection area 406F, a user interface window 400F for viewing column-related data may be provided, as shown in FIG. 4F, including selecting line set size from a group comprising of ¼ inch, ⅜ inch, ½ ich, or ¾ inch, although it may be understood alternative line set sizes are contemplated herein.

Selection area 406G of at least one embodiment of the present invention, such as the embodiment depicted in FIG. 4A, may be interconnected with the step definition sequence module 320 of the setup system 302 and may display a list of recipe steps and components with respective descriptions to enable a user to select components of a recipe of interest listed under the name/code and description of the recipe step. Upon accessing the ‘+’ icon in the selection area 406G, a user interface window 400G may be displayed, such as the one illustrated in FIG. 4G.

As may be seen in FIG. 4G, such a user interface window 400G may provide options for utilizing the various components of the step definition sequence module 320. For instance, through the user interface window 400G, the user may define various step parameters, such as the phase type, pump scheme, name/code, description, process step definition, and flow path. Likewise, user interface 400G may comprise selectable areas for (i) flow path definition, (ii) flow definition, (iii) collection definition, (iv) comparison statements, (v) alarms/limits definition, (vi) flow verification settings, (vii) prompts/operator checks definition, and (viii) flow meter zero parameters. For instance, selectable areas relating to the flow path definition may be configured to receive and store data relating to, for instance, inlet/outlet information, commands including status of bubble trap, guard filter, column, and UV meter selection. For instance, flow path definition component 350 under step definition sequence module 320 is configured to receive and store newly added or edited data, above mentioned data under the flow definition tab.

In the depicted embodiment of FIG. 4G, such selectable areas are accessible through the tabs provided in the user interface window 400G; however, it may be understood alternative methods of providing such selectable areas are envisioned herein. For instance, upon accessing the “Flow” tab of user interface window 400G, user interface window 400H may be displayed as illustrated in FIG. 4H, which may provide a user option to update, edit, reset, and change data for total flow rate, ratio, settings, end criteria, load criteria, and end procedure. Alternatively, selection of such “Flow” tab may instead yield the user interface window 400I depicted in FIG. 4I, which may include additional options and/or means for defining a flow path selection for the flow path definition component 150, such as by configuring the flow definition of the chromatography unit 140, or at least some portion thereof. For instance, isocratic gradient ratio(s), conductivity target(s), and tolerance percentage(s) may be manually adjusted, which may yield automatically calculated values for ratio and tolerance. Meanwhile, additional buttons such as ILC control, pH target, Tolerance, Start % output, and Dead band may all be selected to further configure the flow definition settings of the step at issue. In at least one embodiment, the selection of such additional buttons may yield one or more user interface windows 400 configured to enable a user to define the relevant information for the step definition sequence module 320 via the flow path definition component 350 thereof.

Likewise, accessing the “Collection” tab of user interface window 400G may provide user interface window 400J, an embodiment of which is illustrated in FIG. 4J. As depicted therein, user interface window 400J may provide the user with options to update, edit, reset, and change data for settings, and multiple collection unit settings. Further, upon accessing the comparison statements tab (not shown in FIG. 4I) of user interface window 400G, user interface window 400K may be displayed, as illustrated in FIG. 4K. As shown, user interface window 400K provides the user with options to update, edit, reset, and change data for comparison statements, and logical statements. Again, collection definition component 352 under step definition sequence module 320 is configured to receive and store newly added or edited data, above mentioned data under the collection definition tab. In so doing, the setup system 302 may be configured to define precise collection conditions using the user-configurable collection definition component 352.

The “Alarms/Limits” definition tab of user interface window 400G, enables a user to update, edit, reset, change, and define limits for pH, conductivity to in turn define total flow alarms, pH alarms, conductivity alarms, UV alarms, and alarm conditioning parameters as displayed in user interface window 400L, and illustrated in FIG. 4L. Alarm definition component 354 and limits definition component 356 under step definition sequence module 320 are configured to receive and store newly added or edited data, above mentioned data under the alarms/limits definition tab.

“Flow Verification” tab of user interface window 400G may enable a user to update, edit, reset, change, and define number of test points, a plurality of flow set points, flow stabilization time, and test time parameters, as displayed in user interface window 400M, an example of which is illustrated in FIG. 4M. Flow verification definition component 358 under step definition sequence module 320 is configured to receive and store newly added or edited data, above mentioned data under the flow verification settings tab.

Similarly, the “Prompts/Operator Checks” definition settings tab of user interface window 400G, may enable the user to update, edit, reset, change, define step operator, start prompt, and end prompt parameters as displayed in the user interface window 400N and illustrated in FIG. 4N. Prompt definition component 360 under step definition sequence module 320 is configured to receive and store newly added or edited data, above mentioned data under prompts/operator Check's definition tab.

The “Zero Parameters” tab of user interface window 400G, provides the user with options to update, edit, reset, change, and define flow meter zero parameters including viscosity, window position, gain1, gain 2, up surplus time, down surplus time, differential time, 1 st threshold level, predefined zeros, recipe step zeros, and air detector liquid calibration parameters as displayed in user interface window 400O, and illustrated in FIG. 4O. The zero-parameter definition component 362 under step definition sequence module 320 as described earlier, is configured to receive and store newly added or edited data, above mentioned data under flow meter zero parameters tab.

Thus, it may be understood user interface window 400G may provide the user with options to update, modify, edit, and reset parameters associated with, for instance: the process step definition component 344, the pump scheme definition component 346, the description definition component 348, the flow path definition component 350, the collection definition component 352, the alarm definition component 354, the limit definition component 356, the Returning to FIG. 4A, selection area 406H of at least one embodiment may be interconnected with tabs for the column definition module 312 and the skid definition module 314. Interaction with either such tab may, in at least one embodiment, display user interface(s) 400 through which a user may define the various operations of such modules. For instance, selection of the tab for the column definition module 312 may yield a user interface 400 through which a user may define information relating to the column specifications, such as height, diameter, volume, linear velocity, residence time, and relevant minimum and maximum values for peak identification, as discussed in greater detail heretofore. Likewise, selection of the tab for the skid definition module 314 may yield a user interface 400 through which a user may define information relevant to the skid specification parameters, such as skid line set sizes, as discussed heretofore.

Further, such selection area 406H may additionally comprise tabs for the miscellaneous module 322 and the various modules thereof (collectively grouped in broken lines). For instance, such miscellaneous module 322 may include tabs for column divert setup, manifold prime setup, HETP setup, column types to save/load, pump flow setup, line sanitize setup, and pressure test setup operations.

The “Column Divert Setup” tab of selection area 406H provides the user with options to update, edit, reset, change, and define parameters related to inflight type, inflight volume, outlet divert type, outlet divert volume, pH Ok time, conductivity Ok time, feed fail time, conductivity max/min value, UVI max/min value, UV max/min value via the column divert setup module 364, as displayed in user interface window 400P and illustrated in FIG. 4P. Column divert setup module 364 of miscellaneous setup module 322 is configured to receive and store newly added or edited data, and above mentioned data under the column setup parameters tab. Further, column divert setup module 364 can be configured to receive at least one diversion selection for at least one column station 152.

“Pump Flow Setup” tab of selection area 406H provides users with options to update, edit, reset, change, and define parameters related to flow path definitions, as displayed in user interface window 400Q and illustrated in FIG. 4Q. Pump flow setup module 366 of miscellaneous setup module 322 is configured to receive and store newly added or edited data, and above mentioned data, such as one or more pump flow selections, under the pump speed/flow setup parameters tab.

“Manifold Prime Setup” tab of selection area 406H provides the user with options to update, edit, reset, change, and define parameters related to equipment module feeds in relation to the plurality of valves, as displayed in the user interface window 400R and illustrated in FIG. 4R. Manifold prime setup module 368 of miscellaneous setup module 322 is configured to receive and store newly added or edited data, and above mentioned data, such as priming selection(s), under the manifold prime setup parameters tab.

“HETP Setup” tab of selection area 406H provides the user with options to update, edit, reset, change, and define parameters related to HETP results, asymmetry data, plate height, particle diameter, negative slope time, initial column volume, and PV scan rate as displayed in user interface window 400S and illustrated in FIG. 4S. Manifold prime setup module 372 of miscellaneous setup module 322 is configured to receive and store newly added or edited data, and above mentioned data, such as HETP selection(s), under the HETP setup parameters tab.

“Pressure Test Setup” tab of Selection area 406H provides the user with options to update, edit, reset, change, and define parameters related to manifold, inlet, and outlet pressures as displayed in user interface window 400T and illustrated in 4T. Pressure test setup module 374 of miscellaneous setup module 322 is configured to receive and store newly added or edited data, and above mentioned data, such as pressure test selection(s), under the Pressure test setup parameters tab.

FIG. 5 is a flow diagram of an exemplary embodiment of method 500 for operating chromatography systems 100, 100A in accordance with a purification recipe. Aspects of the example chromatography systems 100, 100A as depicted in FIG. 1A and FIG. 1B, can be utilized in the method steps described below. These example methods 500 may not recite the complete process or all steps of the method. Also, the steps need not necessarily all be performed, and in some cases can be performed simultaneously or in a different order than the order shown.

At step 510, a graphical user interface 162 on a user workstation 160 connected to a chromatography unit 140 is accessed by a user.

At step 520, a purification recipe including a plurality of steps is set up by the user by selecting a plurality of parameters in the various selection areas 406B-406S of the graphical user interface 404. In some embodiments, the user can set up a plurality of purification recipes. The plurality of parameters can include settings for inlet manifold 142, pumps 144, valves 146, bubble trap 147, sensor module 150, column station 152, outlet module 154, alarm component 155, and other peripherals associated with operations of chromatography unit 140.

At step 530, a product is loaded on at least one column 152 in the automated chromatography system 100 based on the instructions for the recipe steps.

At step 540, the purification recipe to purify a target component from the product is run on the chromatography unit 140.

At step 550, the target component is isolated from the product through an outlet 154.

The different embodiments and examples of the chromatography systems and methods described herein provide several advantages over known solutions for purifying a target molecule from a mixture on a column chromatography system. For example, illustrative embodiments and examples described herein allow for the smooth operation of user-friendly recipes on column chromatography by automation, especially in cases where the recipes require a frequent updating of recipe parameters.

Additionally, and among other benefits, illustrative embodiments and examples described herein provide for a complete solution as an extension for downstream process operations.

Additionally, and among other benefits, illustrative embodiments and examples described herein provide for defining, modifying, and selecting raw materials, manifold connections, and the recipes required for operating the chromatography system.

Additionally, and among other benefits, illustrative embodiments and examples described herein provide for the use of default batch recipes that are included which can then be modified, if desired, as a starting point for end-user requirements.

Additionally, and among other benefits, illustrative embodiments and examples described herein provide for a control solution for a chromatography system for downstream processing, either as capture or flow through.

Additionally, and among other benefits, illustrative embodiments and examples described herein provide for a control system that can be configured by end users without the users having to learn process control programming.

Additionally, and among other benefits, illustrative embodiments and examples described herein provide for a customizable chromatography system so that buffer solutions and recipe parameters can be switched easily according to user specifications.

Additionally, and among other benefits, illustrative embodiments and examples described herein are configured to provide a complete, single-use solution for chromatography purification in downstream bioprocessing of recombinant proteins such as monoclonal antibodies and viral vector production.

Additionally, and among other benefits, illustrative embodiments and examples described herein provide for a flexible control system that can support customizations by users for custom solutions or integration into existing plant control systems.

### CONCLUSION

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. A chromatography system comprising:
a chromatography unit communicatively configured in connection with a system controller and a user workstation, said system controller comprising at least one processor and at least one memory having computer-readable instructions disposed thereon and configured for operation of said chromatography unit;
said user workstation configured in input/output communication with said system controller; and
said system controller configured for operation by a control system, said control system configured to define at least one recipe to be performed by said chromatography unit.

2. The chromatography system of claim 1, said control system comprising a setup system configured to define at least one step of said at least one recipe.

3. The chromatography system of claim 2, wherein said setup system is communicatively configured in connection with a support system.

4. The chromatography system of claim 2, wherein said setup system comprises:
a security module configured to provide access to said at least one recipe at said user workstation;
a raw material module configured to define informational data for at least one raw material used in said at least one recipe;
an input manifold connection module configured to associate said at least one raw material with at least one input manifold of said chromatography unit;
a phase module configured to define at least one phase detail for said at least one recipe;
a skid definition module configured to define at least one skid detail for said at least one recipe;
a step definition sequence module configured to define at least one step definition detail for said at least one step of said at least one recipe;
a column definition module configured to define at least one column definition detail for said at least one recipe;
an output module configured to define at least one output detail for said at least one recipe;
a recipe step module configured to perform at least one recipe function relating to said at least one step of said at least one recipe; and
a miscellaneous module configured to define at least one miscellaneous data for said at least one recipe.

5. The chromatography system of claim 1, wherein said system controller comprises a distributed control system, said distributed control system comprising a client-side control component and a plant-side control component.

6. The chromatography system of claim 1, wherein said system controller is communicatively configured in communication with said chromatography unit through at least one intermediary controller.

7. A chromatography system comprising:
a user workstation communicatively configured in connection with a chromatography system, said user workstation comprising a processor disposed in connection with a memory having computer-readable instructions disposed thereon, said processor configured in input/output relation with a user interface configured to display a setup system configured to define at least one recipe to be performed by said chromatography system;
said setup system comprising a step definition sequence module configured to define at least one step definition detail for at least one step of said at least one recipe.

8. The chromatography system of claim 7, wherein said step definition sequence module comprises:
a process step definition component configured to define at least one process step selection for said at least one step;
a pump scheme definition component configured to define at least one pump scheme selection for said least one step;
a description definition component configured to define at least one definition selection for said at least one step;
a flow path definition component configured to define at least one flow path selection for said at least one step;
a collection definition component configured to define at least one collection selection for said at least one step;
an alarm definition component configured to define at least one alarm selection for said at least one step;
a limit definition component configured to define at least one limit selection for said at least one step;
a flow verification component definition component configured to define at least one flow verification selection for said at least one step;
a prompt definition component configured to define at least one prompt selection for said at least one step; and
a zero parameter definition component configured to define at least one zero parameter selection for said at least one step.

9. The chromatography system of claim 8, wherein said at least one flow path selection comprises an automatically calculated value for ratio and tolerance upon receipt of a user input of an isocratic gradient ratio, a conductivity target, and a tolerance percentage.

10. The chromatography system of claim 8, wherein said at least one collection selection comprises
at least one comparison statement and at least one logical statement.

11. The chromatography system of claim 8, wherein said at least one flow verification selection is automatically adjusted upon a change to said at least one flow path selection.

12. The chromatography system of claim 8, wherein said at least one prompt selection is automatically adjusted upon a change to said at least one flow path selection.

13. A chromatography system comprising:
a chromatography unit communicatively configured in connection with at least one user workstation;
said chromatography unit comprising at least one column station disposed in fluid communication with an inlet manifold assembly and an outlet manifold assembly via a fluid transfer assembly;
said fluid transfer assembly disposed in connection with a pump assembly;
said at least one column station further disposed in connection with at least one bubble trap;
said at least one user workstation comprising a processor disposed in connection with a memory having computer-readable instructions disposed thereon, said processor configured in input/output relation with a user interface configured to display a setup system for operating said chromatography system by defining at least one recipe therefor;
said setup system comprising:
a security module configured to provide access to said setup system by a user of said at least one user workstation;
a raw material module configured to define at least one raw material used in said at least one recipe;
an input manifold connection module associate said at least one raw material with at least a portion of said inlet manifold assembly;
an output module configured to define at least one output detail for at least a portion of said outlet manifold assembly;
a column definition module configured to define at least one column definition detail for at least a portion of said at least one column station;
a skid definition module configured to define at least one skid detail;
a phase module configured to define at least one phase detail;
a recipe step module configured to perform at least one recipe function associated with said at least one raw material; and
a step definition sequence module configured to define at least one step definition detail for at least one step of said at least one recipe.

14. The chromatography system of claim 13, wherein said setup system further comprises a miscellaneous setup module, said miscellaneous setup module comprising:
a column divert setup module configured to receive at least one diversion selection for said at least one column station;
a pump flow setup module configured to receive at least one pump flow selection for said pump assembly;
a manifold prime setup module configured to receive at least one priming selection for said inlet manifold assembly;
a line sanitization setup module configured to receive at least one sanitization selection for said inlet manifold assembly;
a HETP setup module configured to receive at least one HETP selection for said at least one column station;
a pressure test setup module configured to receive at least one pressure test selection for said inlet manifold assembly and said pump assembly.

15. The chromatography system of claim 14, wherein said setup system is configured in read/write relation with a support system, said support system comprising a repository module configured to store said at least one step of said at least one recipe.

16. The chromatography system of claim 15, wherein said support system further comprises:
a linking module configured to interlink at least said recipe step module and a step definition sequence module of said setup system; and
an intermediary communication module configured to communicate with at least one intermediary controller communicatively configured between said at least one user device and said chromatography system.

17. The chromatography system of claim 15, wherein said miscellaneous setup module further comprises a column save/load module configured to write said at least one recipe step to said repository module.

18. The chromatography system of claim 13, wherein said step definition sequence module comprises:
a process step definition component configured to define at least one process step selection for said at least one step;
a pump scheme definition component configured to define at least one pump scheme selection for said at least one step;
a flow path definition component configured to define at least one flow path selection for said at least one step, said at least one flow path selection defining at least one flow path parameter for said fluid transfer assembly;
a collection definition component configured to define at least one collection selection for said at least one step, said at least one collection selection defining at least one collection parameter for said outlet manifold assembly;
a flow verification definition component configured to define at least one flow verification selection for said at least one flow path selection;
a zero parameter definition component configured to define at least one zero parameter selection for said at least one step.

19. The control system of claim 18, wherein said chromatography unit further comprises a sensor assembly and at least one alarm component, wherein said step definition sequence module further comprises:
a limit definition component configured to define at least one limit selection for said sensor assembly; and
an alarm definition component configured to define at least one alarm selection for said at least one alarm component based on said at least one limit selection.

20. The chromatography system of claim 18, wherein said at least one collection selection is generated according to a comparison component configured to define at least one comparison statement and at least one logical statement.
